(19) United States
(12) Patent Application Publication
(10) Pub. No.: US 2025/0146755 A1
(43) Pub. Date: May 8, 2025

(54) Outer Cooling Assembly for Structures with Inner Refractory Lining

(71) Applicant: PETRÓLEO BRASILEIRO S.A. - PETROBRAS, Rio de Janeiro (BR)

(72) Inventors: Elbert Fernando Martins Coelho, Contagem (BR); Andre De Oliveira Claudino, Belo Horizonte (BR); Wagner Henrique Saldanha, Sabará (BR)

(73) Assignee: PETRÓLEO BRASILEIRO S.A. - PETROBRAS, Rio de Janeiro, RJ (BR)

(21) Appl. No.: 18/937,324

(22) Filed: Nov. 5, 2024

(30) Foreign Application Priority Data
Nov. 8, 2023 (BR) 1020230233961

(51) Int. Cl. F27D 9/00; B01J 8/18

(52) U.S. Cl. CPC F27D 9/00; B01J 8/1836; B01J 2208/00088; B01J 2208/00212; B01J 2208/00938; F27D 2009/0013; F27D 2009/0018

(57) ABSTRACT

The present invention is applied in the field of heat exchange and temperature regulation and, more specifically, relates to an outer cooling assembly for structures with inner refractory lining, the outer cooling assembly comprising: a distributor arranged on the outer side and around an upper section of a structure with inner refractory lining; and a collector arranged below the distributor and on the outer side and around a lower section of a structure with inner refractory lining; wherein the distributor comprises a fixing plate and cooling fluid injection members arranged on the outer side and around the fixing plate and configured to eject cooling fluid onto the outer surface of the structure.

### CROSS-REFERENCE TO RELATED APPLICATIONS

This application claims priority to Brazilian Application No. BR 1020230233961 filed on Nov. 8, 2023, the disclosure of which is expressly incorporated herein by reference in its entirety.

### FIELD OF THE INVENTION

The present invention is applied in the field of heat exchange and temperature regulation and, more specifically, refers to an outer cooling assembly for application in equipment and structures with inner refractory lining that require constant cooling to regulate the surface temperature within ideal limits for the material.

### BACKGROUND OF THE INVENTION

Currently, in catalytic cracking units, as well as in units in other industrial sectors, structures made of refractory materials are used, such as: converter risers, Fluid Catalytic Cracking (FCC) reactors, towers with inner refractory lining, pipelines with inner refractory lining, among others.

Due to the fact that they are constantly operating in processes that present high temperature ranges, these structures end up losing refractory in their internal walls over time, causing overheating of the side, which consequently leads to a risk of structural failure, with loss of containment and unit shutdown.

In order to solve the problem of overheating of these structures, the state of the art proposes some solutions, such as, for example, the application of steam, by means of outer jetting on the overheated area, to reduce the temperature. However, this solution makes it difficult for an inspection team to visually monitor the situation and is generally insufficient to control the temperature within ideal limits.

Another type of solution proposed by the state of the art consists of the localized application of water to control the temperature in the overheated area. However, this localized application of water is generally irregular and insufficient, and does not cover the entire affected surface. In addition, the localized application of water can reach other nearby equipment, causing corrosion, puddles, risk of injury to people (due to hot water splashes), among others.

Current solutions, therefore, prove to be insufficient and inefficient for adequately controlling the surface temperature of these structures, causing the unit to be shut down to carry out definitive repairs (shutdown, drainage, cutting off the site, and reinstalling the refractory).

In view of these and other related difficulties, there is a need in the state of the art to develop an outer cooling assembly to be implemented in FCC unit converter risers, towers, reactors and other structures with a general tubular, conical or pyramidal shape, with inner refractory lining and used in high temperature processes, capable of distributing the cooling flow uniformly, without risk of injury to people and other nearby equipment, capable of maintaining the temperature of the structure's side within acceptable limits for the material, allowing good visualization of the location, providing constant monitoring, and that can postpone the shutdown of the unit or structure to a next general maintenance shutdown as originally planned.

### STATE OF THE ART

The search for the history led to some documents that disclose matters within the technological field of the present invention.

Document GB732300A describes a process for the continuous operation of a cupola furnace for the production of high-quality iron, which consists of using an excess of carbon in the charge and forcing heated air into the cupola to oxidize the carbon and increase the temperature in the furnace, to melt small quantities of metal oxides in the charge and reduce them directly to metal, while maintaining a reducing atmosphere in the cupola and a slag bath of substantially constant depth, through which the molten metal passes to cause the metal to react with the slag. The temperature of the air entering the furnace is between 400° C. and 600° C., and the slag bath is maintained at a substantially constant depth by providing the furnace with a free slag discharge nozzle at a fixed height, and by maintaining a constant gas pressure within the furnace.

Document GB732300A presents a perforated hose for distributing water around the tower. In other words, this document provides a mechanism that merely presents holes to pour water over the side of the tower, which does not guarantee an ideal control of water flow rate to allow adequate linear flow, not to mention the risks involved in water splashing onto people or other equipment close to the tower.

In turn, document U.S. Pat. No. 1,817,232A describes an apparatus adapted to perform chemical or biological processes at a controlled temperature. The apparatus comprises a receptacle with a wall of material having good conductive properties, the exterior of said wall being divided into a plurality of cooling zones, each provided with means for uniformly supplying and distributing cooling liquid against the outer surface of the wall relative thereto, so that the cooling liquid is caused to flow over the surface of the zone to which it is supplied, and also provided with means for independently regulating the supply of cooling liquid to each zone, and with means for removing the liquid supplied from each zone approximately at that location where said liquid has approximately spent its cooling effect and has reached a temperature very approximately equal to that of the contents of the container adjacent to the zone.

However, document U.S. Pat. No. 1,817,232A, in addition to not being applied to structures with inner refractory lining, does not disclose or suggest devices and mechanisms that provide efficient control of the water distribution flow rate, nor even means for ensuring adequate laminar flow of the cooling liquid from the side.

Finally, document U.S. Pat. No. 2,969,280A of the state of the art discloses a process for producing a cooled aqueous ammonium phosphate fertilizer, comprising separately introducing liquid ammonia, water and phosphoric acid into a first zone and mixing these materials whereby the produced aqueous ammonium phosphate becomes heated to a temperature higher than the temperature of the ammonia, water and phosphoric acid, before mixing divides this heated aqueous ammonium phosphate into two portions, one portion flowing through the inner wall of a second zone, cooling water flowing through the outer wall of said second zone in indirect heat exchange with the descending aqueous ammonium phosphate, whereby the descending aqueous ammonium phosphate becomes cooled to a temperature intermediate to the temperature of the original aqueous ammonium phosphate, water and phosphoric acid and said higher temperature. The process further includes injecting the other portion of said heated aqueous ammonium phosphate into the cooled aqueous ammonium phosphate in said second zone while stirring the same, further cooling the stirred contents of said second zone by indirect heat exchange with a body of cooling water through the bottom of said second zone, passing a portion of the further stirred and cooled liquid contents from said second zone to said first zone to minimize said higher temperature. Furthermore, the process disclosed in U.S. Pat. No. 2,969,280A further comprises regulating the rate of introduction of liquid ammonia into said first zone in response to the temperature of the liquid contents of said second zone, regulating the rates of introduction of water and phosphoric acid into said first zone in predetermined ratios with respect to the introduction of said ammonia to said first zone, and withdrawing the remainder of the other stirred and cooled liquid contents of said second zone as product.

However, document U.S. Pat. No. 2,969,280A, in addition to not being applicable to structures with inner refractory lining, also does not provide efficient and effective means for controlling the flow rate of cooling fluid distribution, nor even means that ensure laminar flow of said fluid through the outer surface of the tubular structure.

### SUMMARY

The present invention consists of the development of an outer cooling assembly capable of cooling the temperature of the side of towers, FCC risers, reactors and other structures with refractory lining, maintaining the temperature within acceptable limits for the material.

The assembly provides better visualization of the overheated location and the possibility of constant monitoring. In addition, it means that occasional shutdowns of the unit for carrying out repairs to the structure can be postponed until the next general maintenance shutdown as originally planned.

The solution proposed by the present invention provides an upper water distributor (weir), which allows a uniform/homogeneous distribution of water (cooling fluid) over the entire surface of the structure; and a lower collector (gutter) that directs the heated water to a safe location.

The water distribution made by the weir generates a laminar flow of water over the entire surface of the heated structure, which allows visual monitoring of the affected region by a monitoring team, in addition to being effective in maintaining the temperature of the surface of the side within acceptable limits for the material.

In addition, the laminar flow generated by the upper distributor, aligned with the use of the lower collector, eliminates the risk of damage to nearby equipment, and manages to prevent the release of hot water in the vicinity, significantly reducing the risk of accidents in the surroundings, when compared with the solutions previously applied by the state of the art.

Accordingly, the advantages and objectives of the present invention are achieved by providing an outer cooling assembly for structures with inner refractory lining, the outer cooling assembly comprising: a distributor disposed on the outer side of and around an upper section of a structure with inner refractory lining; and a collector disposed below the distributor and on the outer side of and around a lower section of a structure with inner refractory lining; wherein the distributor comprises a fixing plate and cooling fluid injection members disposed on the outer side of and around the fixing plate and configured to eject cooling fluid onto the outer surface of the structure.

### BRIEF DESCRIPTION OF THE FIGURES

The preferred embodiments of the subject invention will be better understood when read in conjunction with the accompanying drawings. It should be understood, however, that the subject invention is not limited solely to the precise arrangements and instruments as shown.

Thus, the present invention will be described below with reference to its typical embodiments and also with reference to the attached drawings, in which:

FIG. 1 shows an isometric view of a distributor of an outer cooling assembly, according to an embodiment of the present invention.

FIG. 2 shows an isometric view of a collector of an outer cooling assembly, according to an embodiment of the present invention.

FIG. 3 shows a front view of the distributor of the outer cooling assembly, according to an embodiment of the present invention.

FIG. 4 shows a top view of the distributor of the outer cooling assembly, according to an embodiment of the present invention.

FIG. 5 shows a sectional view “A-A” from FIG. 4 of the distributor of the outer cooling assembly, according to an embodiment of the present invention.

FIG. 6 shows a front view of the collector of the outer cooling assembly, according to an embodiment of the present invention.

FIG. 7 shows a top view of the collector of the outer cooling assembly, according to an embodiment of the present invention.

FIG. 8 shows a sectional view “A-A” from FIG. 7 of the collector of the outer cooling assembly, according to an embodiment of the present invention.

FIG. 9 shows a sectional view “B-B” from FIG. 7 of the collector of the outer cooling assembly, according to an embodiment of the present invention.

FIG. 10 shows a sectional view “C-C” from FIG. 7 of the collector of the outer cooling assembly, according to an embodiment of the present invention.

FIG. 11 shows a detail view “D” from FIG. 6 of the collector of the outer cooling assembly, according to an embodiment of the present invention.

FIG. 12 shows a sectional view “E-E” from FIG. 11 of the collector of the outer cooling assembly, according to an embodiment of the present invention.

### DETAILED DESCRIPTION OF THE INVENTION

In the following, reference is made in detail to the preferred embodiments of the present invention illustrated in the accompanying drawings. Whenever possible, the same or similar reference numerals will be used throughout the drawings to refer to the same or similar features. It should be noted that the drawings are in simplified form and are not represented to precise scale, so that slight variations are anticipated.

The present invention relates to an outer cooling assembly to be applied to structures with inner refractory lining, such as FCC risers, FCC reactor sides, towers and pipelines.

The implementation of the assembly of the present invention allows a uniform cooling along the entire outer surface of the tower side or structure with refractory lining, by means of a laminar flow of the cooling fluid. This flow allows both adequate visualization of the overheating site and promotes greater operational safety, since the cooling fluid flows along the outer surface of the structure in a laminar manner, without causing splashes of heated water in the surroundings.

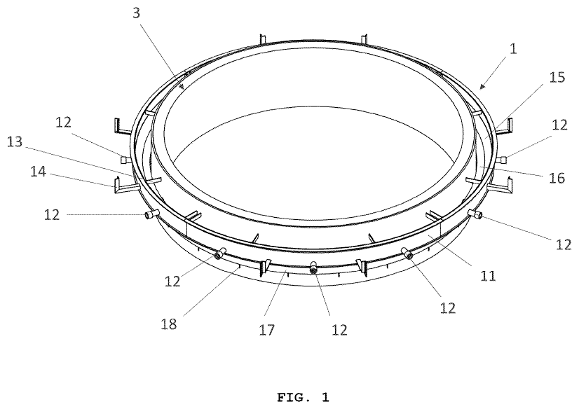

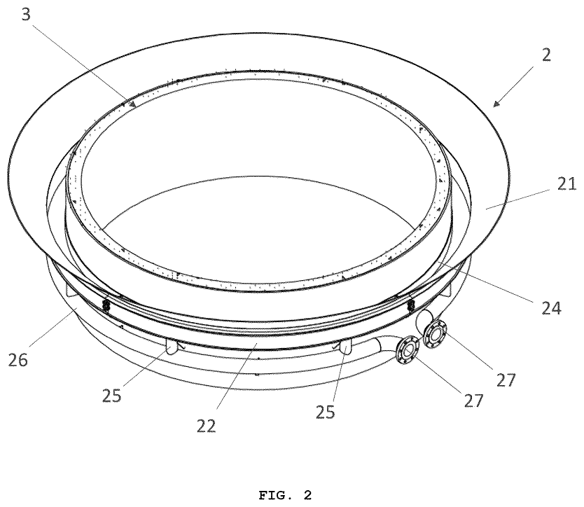

Reference is made to FIGS. 1 and 2, which show a distributor (or weir) 1 and a collector (or gutter) 2, respectively, of an outer cooling assembly, according to an embodiment of the present invention. In this embodiment, the outer cooling assembly for structures with inner refractory lining comprises: a distributor 1 in a general circular or elliptical shape arranged on the outer side and around an upper section of a structure with inner refractory lining 3; and a collector 2 in a generally circular or elliptical shape arranged below the distributor 1 and on the outer side and around a lower section of a structure with inner refractory lining 3. It should be noted that the distributor 1 is mounted on an upper section of the structure 3, close to the top or in intermediate sections that are below the top, and surrounds the entire periphery or outer diameter of the structure 3, while the collector 2 is mounted at a certain distance below the distributor 1, also so as to surround the entire periphery or outer diameter of the structure 3.

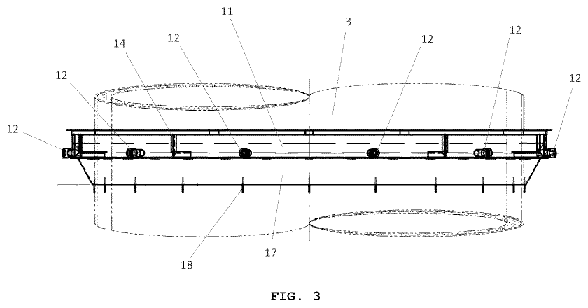

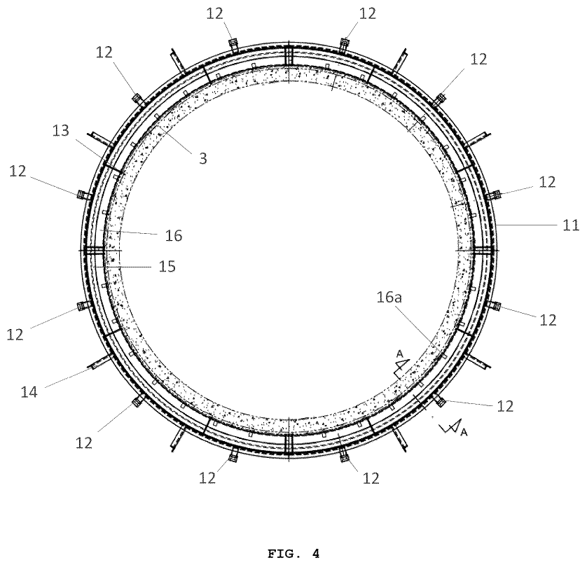

Furthermore, as shown in FIGS. 3 and 4, the distributor 1 comprises a fixing plate 11 and cooling fluid injection members 12 arranged on the outer side and around the fixing plate 11 and configured to eject cooling fluid onto the outer surface of the structure 3, wherein the cooling fluid injection members 12 are uniformly distributed along the fixing plate 11, that is, each cooling fluid injection member 12 is equidistant in relation to two other adjacent cooling fluid injection members 12, one upstream and one downstream, in the direction along the perimeter of the plate 11. In one embodiment of the present invention, the distributor 1 has twelve cooling fluid injection members 12, one every 30°, around the fixing plate 11. However, the number of cooling fluid injection members 11 may vary, so as to have more or less than twelve, maintaining the uniform distribution ratio along the fixing plate 11.

It is also emphasized that, in some embodiments of the present invention, the fixing plate 11 is formed by a single piece (one piece) or by the connection of more than one piece segment (segmented).

Furthermore, each cooling fluid injection member 12 has individual valve flow rate control, in order to regulate the flow rate of cooling fluid that is injected into each member 12 and ejected to the outer surface of the structure 3. An example of a cooling fluid used by the present invention is water; however, other cooling fluids commonly used in the industry can be used without departing from the objectives of the present invention and according to the perceived need.

The distributor 1, according to an embodiment of the present invention, further comprises support members 13 arranged on the inner side of the fixing plate 11 to support the distributor 1 against the outer surface of the structure 3, in order to prevent the distributor 1 from sliding in the longitudinal direction of the structure 3. Accordingly, the support 13 allows a connection between the structure 3 and the fixing plate 11, and better fixation, positioning and rigidity of the assembly.

The element 14 is a support for water (or fluid) supply hoses for injection into a collector or gutter 2.

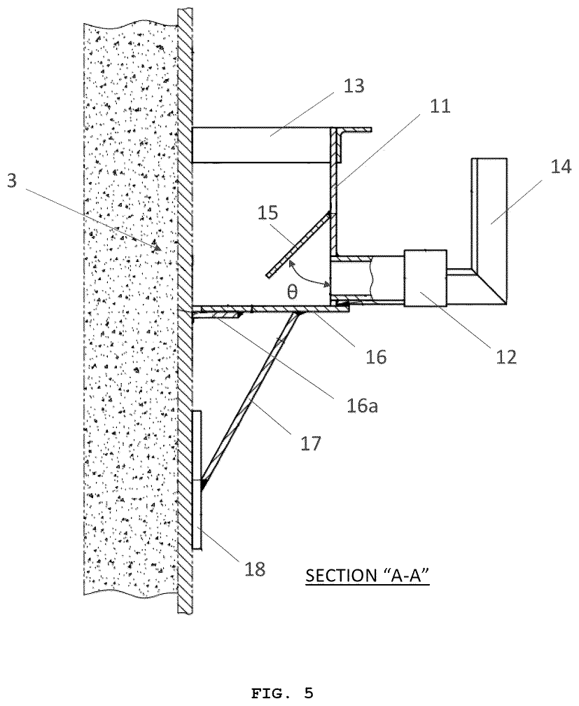

Furthermore, the distributor 1 has a bulkhead plate 15, mounted on the inner side of the fixing plate 11 and above the fluid release end of the cooling fluid injection member 12. As shown in FIG. 5, the bulkhead plate 15 forms an angle θ in relation to the fixing plate 11, being configured to reduce and prevent splashes from the inlet of the cooling fluid that was injected with speed from the fluid release end of the cooling fluid injection member 12 from being directed out of the distributor 1, and so as to improve the internal distribution of the water. In one embodiment of the present invention, the angle θ varies between about 35° and about 90°, preferably being about 45°, but should be adjusted during assembly to improve the distribution of the fluid throughout the region of the gutter and eliminate splashing.

As best seen in FIGS. 4 and 5, the distributor 1 further comprises a bottom plate 16, substantially perpendicular to the fixing plate 11, having openings 16a, so that the injected cooling fluid fills an entire region of fluid accumulation on the bottom plate 16 and flows through the openings 16a. After passing through the openings 16a, the cooling fluid flows through a weir plate 17, which is tapered to conduct the cooling fluid towards a gap formed between the weir plate 17 and the outer surface of the structure 3.

According to an embodiment of the present invention, the width of the gap is defined by means of spacers 18 distributed equally, that is, equidistant from each other, around the structure 3.

In this way, the cooling fluid that is injected fills the entire accumulation region in the distributor 1, being conducted to the outer surface (side) of the structure 3 by the weir plate 17 with a gap of uniform width/spacing along the entire diameter of the side of the structure 3, the gap being formed due to the use of the spacers 18 between the side/outer surface of the structure 3 and the weir plate 17. This spacing allows the cooling fluid uniformly and laminarly flow over the entire outer surface of structure 3 to be cooled.

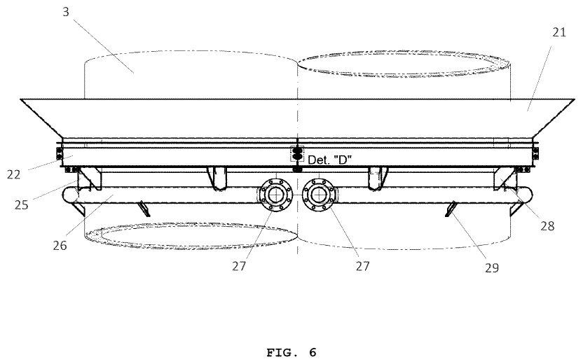

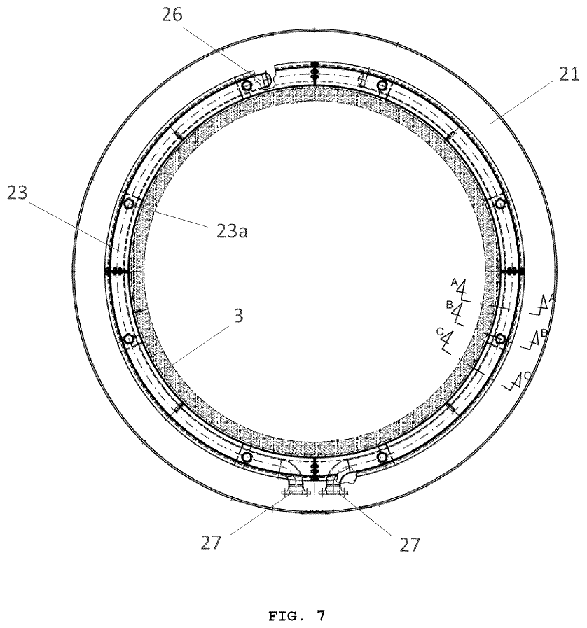

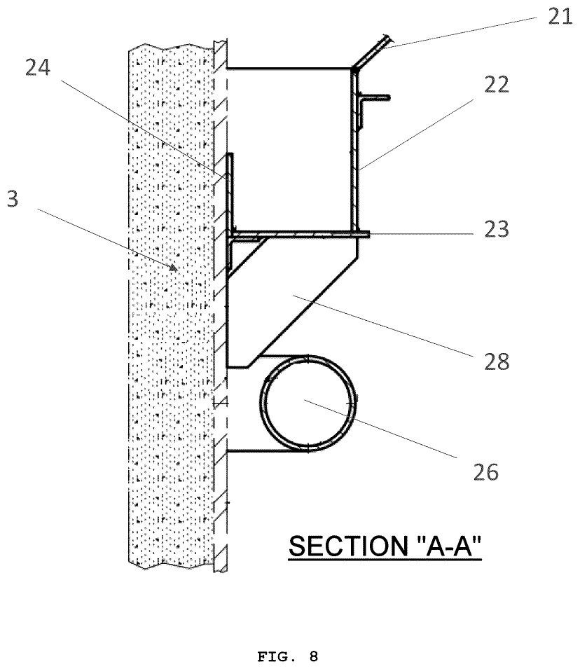

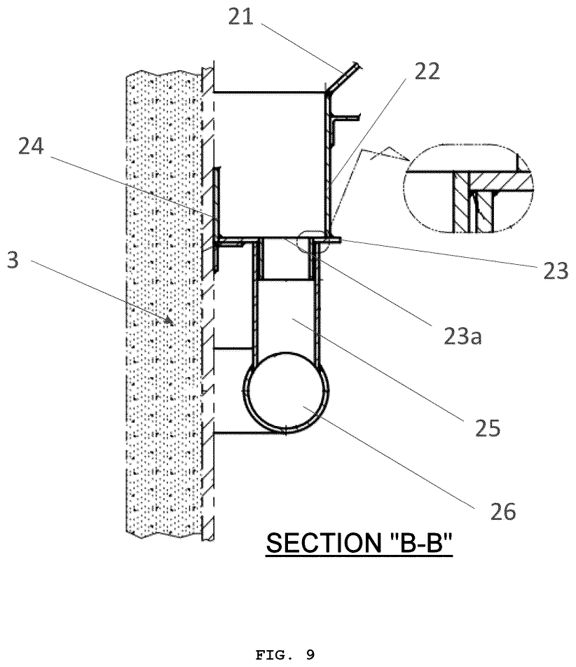

After passing through the outer surface of the structure 3, the exhausted cooling fluid flows to the collector 2, located below the region cooled by the fluid, with the fluid being received in a tapered upper portion 21 of the collector 2, as shown in FIGS. 6 to 10.

Furthermore, the collector 2 further comprises a straight intermediate portion 22, a bottom portion 23 and a protective portion 24, so that the region formed by the union of the three portions has a “U” profile for receiving and damming the exhausted fluid coming from the tapered upper portion 21 and the outer surface of the structure 3. It should be noted that the protective portion 24 is fitted around a section of the outer surface of the structure 3 in a fixed way, covering the same so that there is no gap between the collector 2 and the outer surface of the structure 3, thus preventing the exhausted fluid from flowing directly through the outer surface 3 without passing through the collector 2.

Additionally, the exhausted cooling fluid accumulated in the region with a “U” profile flows through a plurality of holes 23a distributed along the bottom portion 23, wherein each hole 23a is connected to a respective connecting pipe 25. Each connecting pipe 25, in turn, is connected to a portion of a circular pipe 26, so that the fluid flows through the connecting pipes 25 until it is discharged into the circular pipe 26 and, subsequently, directed to ejection nozzles 27 of the circular pipe 26, being dispensed outside the pipe circuit in a safe location.

In one embodiment of the present invention, support members 28 are connected along the lower surface of the bottom portion 23 of the collector 2 to the outer surface of the structure 3. Likewise, support members 29 are connected along the lower surface (close to the generatrix of the circular section) of the circular pipe 26. Thus, the support members 28, 29 act to secure the collector 2 to the outer surface of the structure 3 and prevent the collector 2 from sliding in the longitudinal direction of the axis of the structure 3.

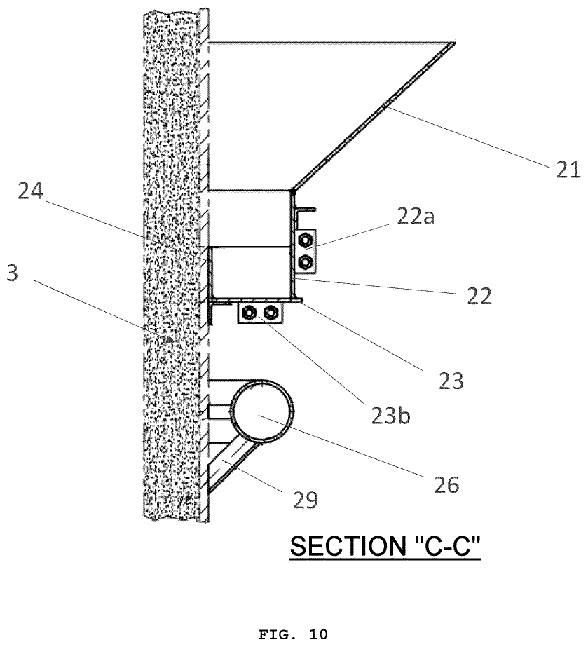

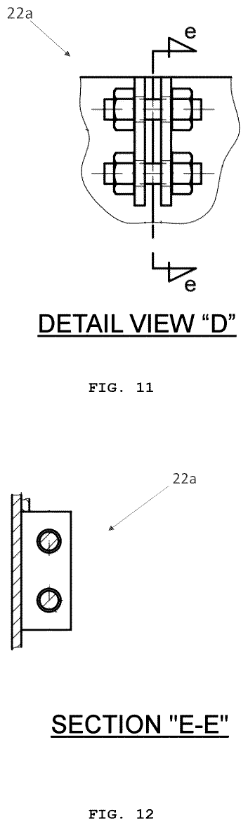

Additionally, as shown in FIGS. 10 to 12, both the straight intermediate portion 22 and the bottom portion 23 are connected, respectively, to an adjacent straight intermediate portion 22 and to an adjacent bottom portion 23 by means of fixing elements 22a, 23b (such as nuts, bolts, rivets, among others). That is, the straight intermediate portion 22 and the bottom portion 23 are formed by connecting more than one segment of respective straight intermediate portions 22 and bottom portions 23. However, in other embodiments of the present invention, it is possible for the straight intermediate portion 22 and the bottom portion 23 to be formed by a single piece section, without the use of fixing elements.

Those skilled in the art will appreciate the knowledge presented herein and will be able to reproduce the invention in the presented embodiments and in other variants, encompassed by the scope of the attached claims.

1. An outer cooling assembly for structures with inner refractory lining, the outer cooling assembly comprising:
a distributor arranged on the outer side and around an upper section of a structure with inner refractory lining; and
a collector arranged below the distributor and on the outer side and around a lower section of a structure with inner refractory lining;
wherein the distributor comprises a fixing plate and cooling fluid injection members arranged on the outer side and around the fixing plate and configured to eject cooling fluid onto the outer surface of the structure.

2. The outer cooling assembly according to claim 1, wherein the cooling fluid injection members are uniformly distributed along the fixing plate.

3. The outer cooling assembly according to claim 1, wherein the fixing plate is formed by a single piece or by the connection of more than one piece segment.

4. The outer cooling assembly according to claim 2, wherein each cooling fluid injection member has individual valve flow rate control.

5. The outer cooling assembly according to claim 4, wherein the distributor has a bulkhead plate mounted on the inner side of the fixing plate and above the fluid release end of the cooling fluid injection member.

6. The outer cooling assembly according to claim 5, wherein the bulkhead plate forms an angle (θ) in relation to the fixing plate, being configured to prevent splashes from the injected cooling fluid from the fluid release end of the cooling fluid injection member from being directed out of the distributor.

7. The outer cooling assembly according to claim 5, wherein the distributor further comprises a bottom plate, perpendicular in relation to the fixing plate, having openings, so that the injected cooling fluid fills an entire region of fluid accumulation on the bottom plate and flows through the openings.

8. The outer cooling assembly according to claim 5, wherein the distributor further comprises a weir plate that is tapered to conduct the cooling fluid from the openings towards a gap formed between the weir plate and the outer surface of the structure.

9. The outer cooling assembly according to claim 8, wherein the width of the gap is defined by means of spacers distributed equally around the structure and arranged between the outer surface of the structure and the weir plate.

10. The outer cooling assembly according to claim 1, wherein the exhausted cooling fluid, after flowing through the outer surface of the structure, is received in a tapered upper portion of the collector.

11. The outer cooling assembly according to claim 1, wherein the collector further comprises a straight intermediate portion, a bottom portion and a protection portion, so that the region formed by the union of the three portions has a “U” profile for receiving and damming the exhausted fluid coming from the tapered upper portion and the outer surface of the structure.

12. The outer cooling assembly according to claim 11, wherein the exhausted cooling fluid accumulated in the region with a “U” profile flows through a plurality of holes distributed along the bottom portion, wherein each hole is connected to a respective connection tube.

13. The outer cooling assembly according to claim 12, wherein each connecting tube is connected to a portion of a circular pipe, so that the fluid flows through the connecting tubes until it is poured into the circular pipe and, subsequently, directed to ejection nozzles of the circular pipe, being dispensed outside the pipe circuit in a safe location.
